(19) United States
(12) Patent Application Publication
(10) Pub. No.: US 2013/0231973 A1
(43) Pub. Date: Sep. 5, 2013

(54) BUSINESS ANALYSIS DESIGN SUPPORT DEVICE, BUSINESS ANALYSIS DESIGN SUPPORT METHOD AND NON-TRANSITORY COMPUTER-READABLE MEDIUM CONTAINING BUSINESS ANALYSIS DESIGN SUPPORT PROGRAM

(71) Applicant: HITACHI, LTD., Tokyo (JP)

(72) Inventors: Hideyuki KANUKA, Yokohama-shi (JP); Haruhiko NISHIYAMA, Chigasaki-shi (JP); Masataka ARAKI, Kawasaki-shi (JP)

(73) Assignee: HITACHI, LTD., Tokyo (JP)

(21) Appl. No.: 13/779,671

(22) Filed: Feb. 27, 2013

(30) Foreign Application Priority Data
Mar. 1, 2012 (JP) 2012-045752

(51) Int. Cl. G06Q 10/06

(52) U.S. Cl. CPC G06Q 10/0633
USPC 705/7.27

(57) ABSTRACT

To efficiently maintain consistency between deliverables in business analysis design, a computer performs processing of searching concatenation of predetermined words defined in each business use case description among the business use case descriptions, specifying relation among the business use cases to associate the business use cases with each other, and generating a business use case flow according to the association, processing of specifying a business function which is a higher-level of each business use case included in the business use case flow with information on business function hierarchy in a business function hierarchy storage unit, specifying concatenation of the business use cases extending across different business functions in the business use case flow, and associating the business functions with each other according to the concatenation to generate a business flow; and processing of displaying the business use case flow or the business flow generated on a display device.

### CROSS-REFERENCE TO RELATED APPLICATION(S)

The present application claims priority upon Japanese Patent Application No. 2012-45752 filed on Mar. 1, 2012, which is herein incorporated by reference.

### BACKGROUND

1. Field of the Invention

The present invention relates to a business analysis design support device, a business analysis design support method and a non-transitory computer-readable medium containing a business analysis design support program, and more specifically relates to a technology that efficiently maintains the consistency between deliverables in a business analysis design.

2. Related Art

In an upstream process of business system development, the current state of a target business is analyzed, and a new business design is performed. As typical deliverables in this business analysis design, a business function hierarchy and a business flow are produced. The business function hierarchy is data obtained by dividing an entire business into functions ranging from a large function to a small function and structuring the functions, and clarifies what business functions the business is formed with. The business flow is data that illustrates an order relationship among business functions, and clarifies in what order the business functions need to be performed.

On the other hand, the details of business functions equal to or smaller than a small function are described in text. As one of the text description formats, there is a method of utilizing a business use case description. The business use case description is data in which a mutual relationship with others that is required for a business worker to perform a small function of business functions is regarded as a business use case, and in which the behavior of actors (persons involved in the use case such as the business worker and the others) required for realizing the business use case is described in simple text lines.

As described above, the business function hierarchy, the business flow and the business use case description produced in a business analysis design are related to each other, and their consistency needs to be maintained. As a technology for maintaining this consistency, for example, Japanese Patent Application Laid-Open Publication No. 2008-129858 corresponding to U.S. Patent Application Publication No. US2008/0120581 proposes a design/verification support program in which “either of a use case diagram or an activity diagram is provided to automatically generate the other diagram, and thus it is possible to acquire the consistency between both diagrams.”

### SUMMARY OF THE INVENTION

In a conventional technology, a relation between use cases needs to be previously defined as a use case diagram. Since the relation between the use cases is related to the behavior of actors described in use case descriptions that are details of the use cases, it is necessary to acquire the consistency between the relation between the use cases and the use case descriptions. In order to acquire this consistency, it is necessary for a person to read the text of the use case descriptions and grasp the relation between the use case descriptions. When a target for an analysis design is wide, and thus the number of use case descriptions is increased or when use case descriptions are often modified in an initial stage of an analysis design, it is likely that, in order to maintain the consistency described above, a large amount of time and efforts are taken.

Here, the business use case is one type of use case specialized in business description. Hence, the same problem as described above is encountered in the consistency between the relation between the business use case descriptions and a business use case flow expressing the order relationship between the business use cases. In particular, in the stage of a business analysis design, since the current business is analyzed and then a new business design is performed, the details of deliverables (such as a business use case description and a business use case flow) are highly likely to be finely modified. Hence, it is highly likely that, in order to maintain the consistency between the deliverables, a large amount of time and efforts are taken, and this is more likely to become a factor for preventing the original operation of the business analysis design.

An object of the present invention is therefore to provide a technology that efficiently maintains the consistency between deliverables in a business analysis design.

To solve the above problem, according to the present invention, there is provided a business analysis design support device including: a storage device that includes: a business function hierarchy storage unit that stores information on a business function hierarchy where an entire business is structured in a stepwise manner and information on a business use case which is an element of a lowermost layer of the business function hierarchy; and a business use case description storage unit that stores a business use case description forming the business use case; and a computation device that performs: processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association; processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and processing of displaying the business use case flow or the business flow generated on a display device.

According to the present invention, there is provided a business analysis design support method, where a computer, which includes a storage device including a business function hierarchy storage unit storing information on a business function hierarchy where an entire business is structured in a stepwise manner and information on a business use case which is an element of a lowermost layer of the business function hierarchy, and a business use case description storage unit storing a business use case description forming the business use case, performs: processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association; processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and processing of displaying the business use case flow or the business flow generated on a display device.

According to the present invention, there is provided a non-transitory computer-readable medium containing a business analysis design support program, causing a computer, which includes a storage device including a business function hierarchy storage unit storing information on a structured business function hierarchy and information on a business use case which is an element of a lowermost layer of the business function hierarchy, and a business use case description storage unit storing a business use case description forming the business use case, to perform: processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association; processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and processing of displaying the business use case flow or the business flow generated on a display device.

According to the present invention, it is possible to efficiently maintain the consistency between deliverables in a business analysis design.

### BRIEF DESCRIPTION OF THE DRAWINGS

FIG. 1 is a diagram showing an example of a hardware configuration of a business analysis design support device according to the present embodiment;

FIG. 2 is a diagram showing an example of a functional block of the business analysis design support device according to the present embodiment;

FIG. 3 is a diagram showing an example of a configuration of a business function hierarchy table included in the business analysis design support device according to the present embodiment;

FIG. 4 is a diagram showing an example of a configuration of a business use case table included in the business analysis design support device according to the present embodiment;

FIG. 5 is a diagram showing an example of a configuration of a business use case description table included in the business analysis design support device according to the present embodiment;

FIG. 6 is a diagram showing an example of a configuration of a verb table included in the business analysis design support device according to the present embodiment;

FIG. 7 is a diagram showing an example of a configuration of a business use case relation table included in the business analysis design support device according to the present embodiment;

FIG. 8 is a diagram showing an example of a configuration of a business function relation table included in the business analysis design support device according to the present embodiment;

FIG. 9 is a flow diagram showing a processing procedure example 1 of a business analysis design support method according to the present embodiment;

FIG. 10 is a flow diagram showing a processing procedure example 2 of the business analysis design support method according to the present embodiment;

FIG. 11 is a diagram showing an example of a configuration of a business function hierarchy edition screen included in the business analysis design support device according to the present embodiment;

FIG. 12 is a diagram showing an example of a configuration of a business use case description edition screen included in the business analysis design support device according to the present embodiment;

FIG. 13 is a diagram showing an example of the configuration of the business function hierarchy edition screen included in the business analysis design support device according to the present embodiment;

FIG. 14 is a diagram showing an example of a business use case flow display according to the present embodiment;

FIG. 15 is a diagram showing a business flow display example 1 according to the present embodiment; and

FIG. 16 is a diagram showing a business flow display example 2 according to the present embodiment.

### DESCRIPTION OF THE EMBODIMENT

—An Example of a Configuration of a Device—

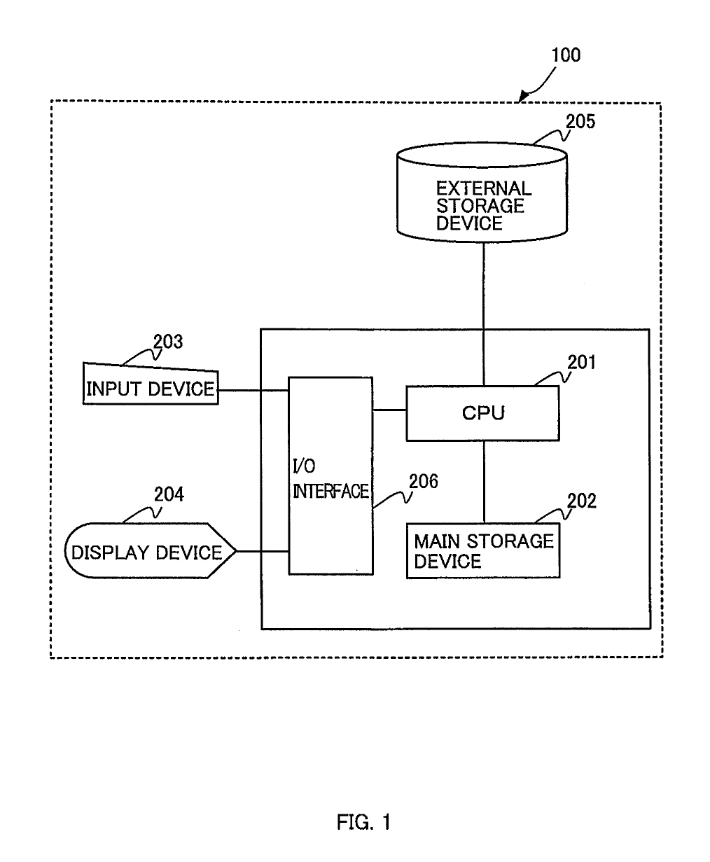

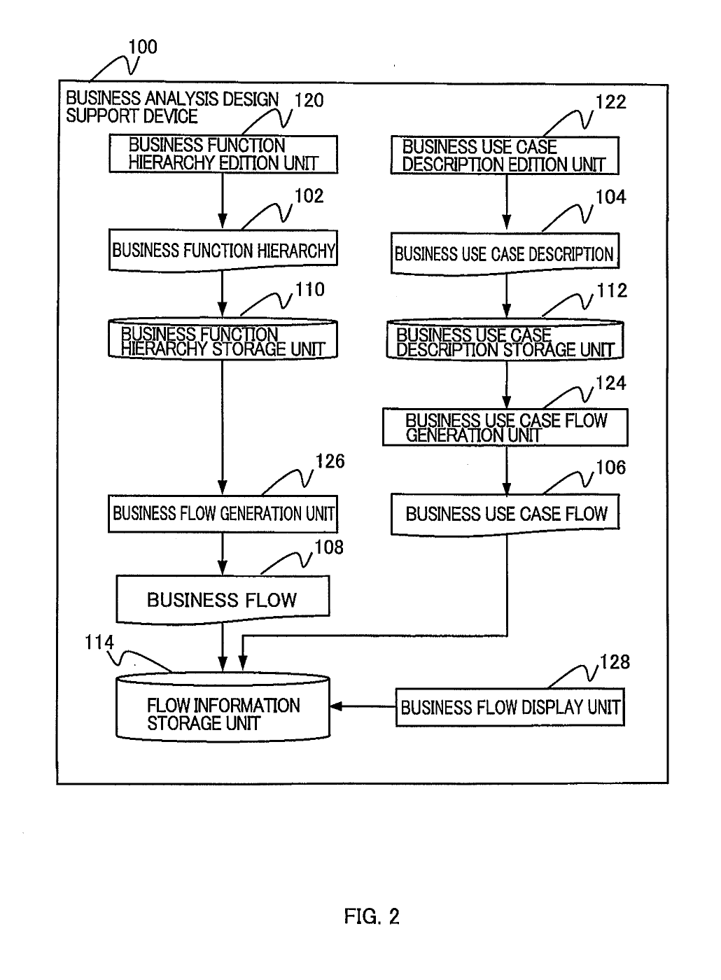

An embodiment of the present invention will be described in detail below with reference to accompanying drawings. FIG. 1 is a diagram showing an example of the hardware configuration of a business analysis design support device 100 according to the present embodiment; FIG. 2 is a diagram showing an example of the system configuration of the business analysis design support device 100 according to the present embodiment. Like reference numerals refer to like constituent elements. This business analysis design support device 100 is a computer system that efficiently maintains the consistency between deliverables in a business analysis design.

As shown in FIG. 1, the business analysis design support device 100 is a calculator system that includes: a CPU 201 which is a computation device; a main storage device 202 which is formed with a volatile storage device such as a RAM; an input device 203 which receives a key input or a sound input from a user; a display device 204 such as a display for displaying processing data; an external storage device 205 (storage device) which is formed with an appropriate nonvolatile storage device such as a hard disk drive; and an I/O interface 206 which exchanges data between the input device 203 and the display device 204 and the CPU 201.

The I/O interface 206 mounts: an input interface circuit unit that receives an input signal from the input device 203 and delivers it to the CPU 201; and an output interface circuit unit that delivers an output signal from the CPU 201 to the display device 204. The business analysis design support device 100 can couple, in addition to the elements described above, other output devices such as various printers.

As shown in FIG. 2, the external storage device 205 stores computer programs that function as a business function hierarchy edition unit 120, a business use case description edition unit 122, a business use case flow generation unit 124 and a business flow generation unit 126, which will be described later. In addition, the external storage device 205 stores databases as a business function hierarchy storage unit 110, a business use case description storage unit 112 and a flow information storage unit 114. The external storage device 205 may be provided separately from the business analysis design support device 100 or may be formed integrally with the business analysis design support device 100.

The programs forming the business function hierarchy edition unit 120, the business use case description edition unit 122, the business use case flow generation unit 124, the business flow generation unit 126 described above and a business flow display unit 128 are read by the CPU 201 from the external storage device 205, are expanded to the main storage device 202 formed with a memory, for example, such as a RAM and are executed by the CPU 201, thereby realizing the functions.

—An Example of a Structure of Data—

Next, an example of the structure of data used by the business analysis design support device 100 of the present embodiment will now be described. The business function hierarchy storage unit 110 will first be described. As described above, the business function hierarchy storage unit 110 includes: a business function hierarchy table 700 that is the database stored in the external storage device 205, that is produced in the business function hierarchy edition unit 120 described later, that is a constituent element of a business function hierarchy 102 and that stores data indicating a hierarchy relationship between business functions; and a business use case table 300 that stores data on the business use case which is an element in the lowermost layer of the business function hierarchy 102.

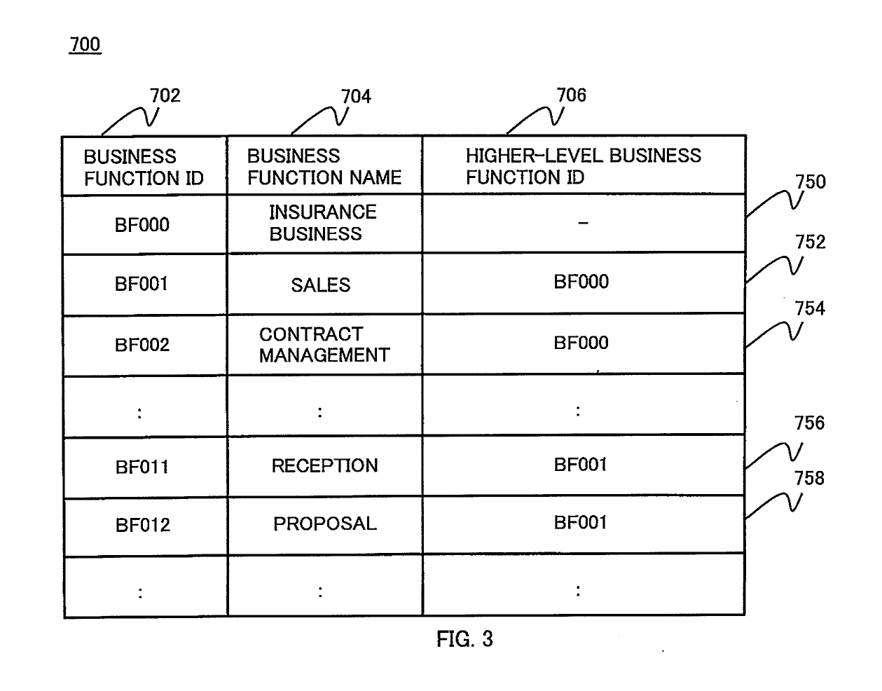

The above-mentioned tables 300 and 700 stored in the business function hierarchy storage unit 110 will be described below in turn. FIG. 3 shows an example of the business function hierarchy table 700. In the business function hierarchy table 700, a business function ID 702 is data that identifies record data on the business function hierarchy table 700. Likewise, a business function name 704 indicates the name of a business function forming a business, and a higher-level business function ID 706 is a pointer for a record indicating a higher-level business function of a business function defined in the record.

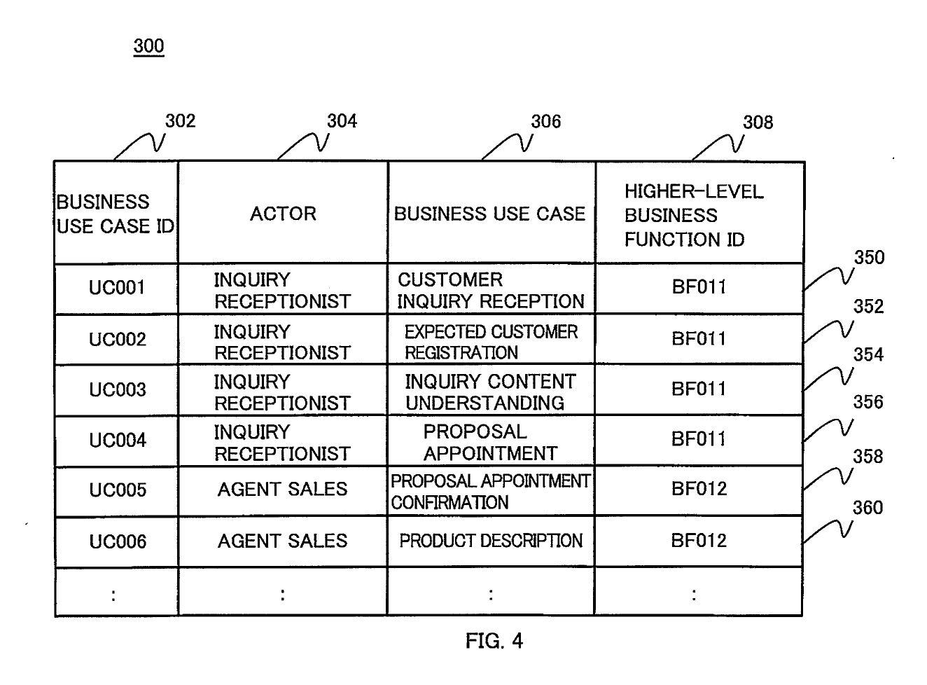

FIG. 4 shows an example of data defined in the business use case table 300. In the business use case table 300, a business use case ID 302 is data that identifies record data on the business use case table. Likewise, an actor 304 is data that indicates a main operational body performing a business whose details are defined in the business use case description or a business worker. Likewise, a business use case 306 is data that indicates the name of the business use case. Likewise, a higher-level business function ID 308 is a pointer for a record indicating a higher-level business function of a business use case defined in the record, and the business function ID 702 stored in the business function hierarchy table 700 enters the higher-level business function ID 308.

Subsequently, the business use case description storage unit 112 will now be described. As described above, the business use case description storage unit 112 is configured to include: a business use case description table 400 that is a database stored in the external storage device 205, that is produced in the business use case description edition unit 122 described later and that stores data on a business use case description 104 defining the content of the business use case; and a verb table 500 that stores pattern data on syntaxes and verbs necessary for defining the business use case description 104.

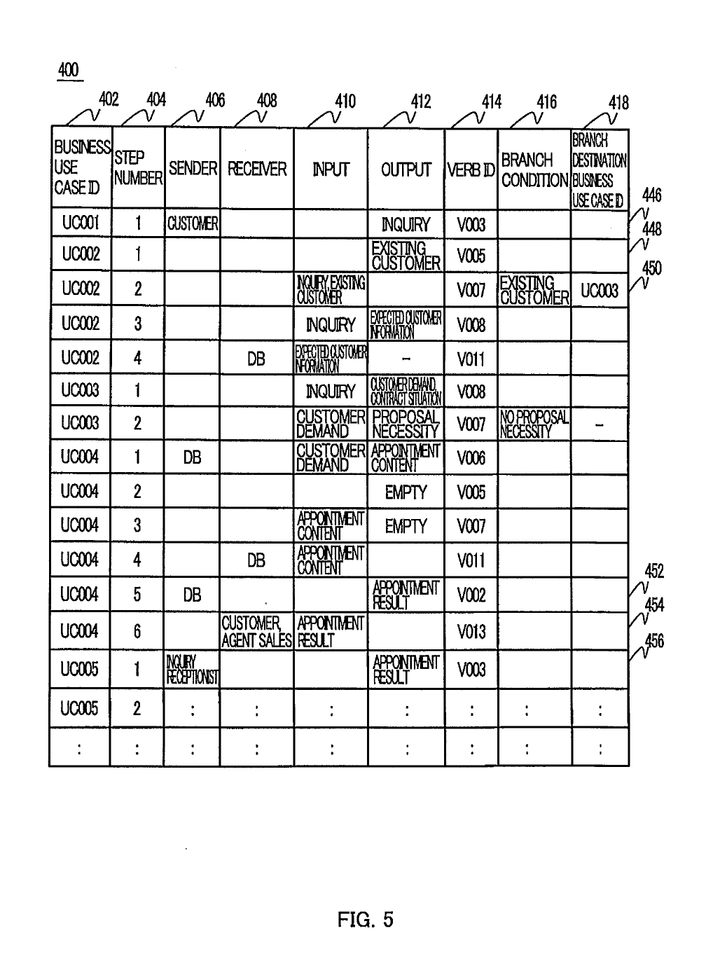

The tables stored in the business use case description storage unit 112 will be described below in turn. FIG. 5 shows an example of data defined in the business use case description table 400. In the business use case description table 400, a business use case ID 402 corresponds to a business use case description defined by the record, and is a pointer of a record indicating a business use case defined in the business use case table 300 and the business use case ID 302 stored in the business use case table 300 enters the business use case ID 402.

Likewise, a step number 404 is data for ordering steps within a business use case description identified by the same business use case ID 402. Likewise, a sender 406 is data that indicates an actor which is a source of an operation prescribed by a verb specified by a verb ID 414. Likewise, a receiver 408 is data that indicates an actor which is a receiver of the operation prescribed by the verb specified by the verb ID 414. Likewise, an input 410 indicates data that is necessary for the operation of the actor. Likewise, an output 420 indicates data that is generated by the operation of the actor. Likewise, a verb ID 502 in the verb table 500 storing verbs indicating operations enters the verb ID 414. Whether or not data enters the items of the sender 406, the receiver 408, the input 410 and the output 412 is judged by verbs specified by the verb ID 414. Likewise, data indicating a condition for transition to another step operation in an order defined by the step number 404 as a result of the operation enters a branch condition 416, and a transition destination under this condition is specified by a branch destination business use case ID 418. When “-” enters the branch destination business use case ID 418, this means the completion of the business.

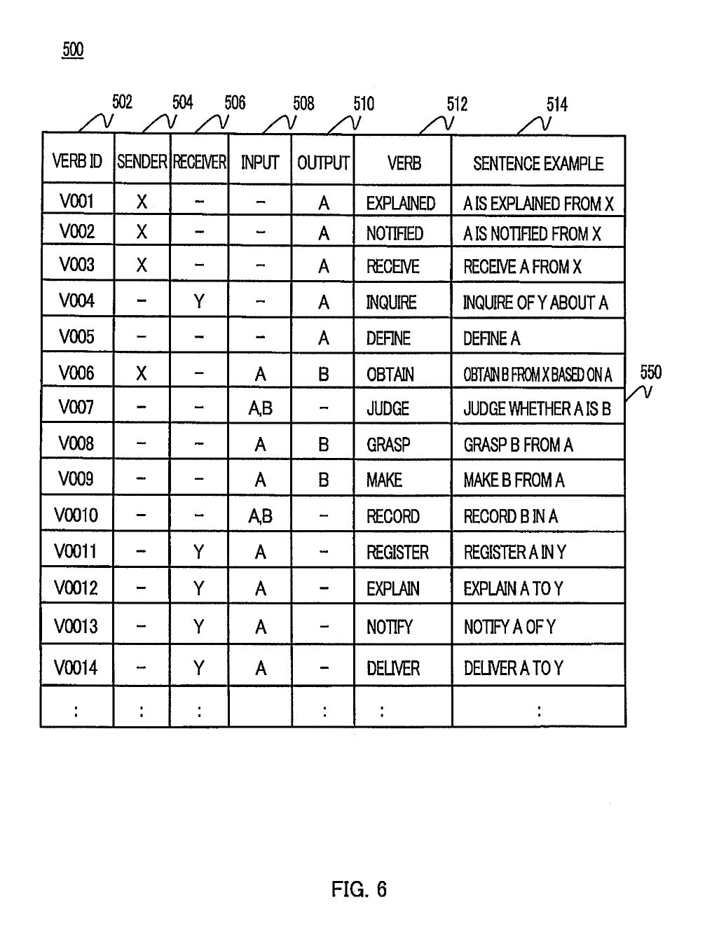

FIG. 6 shows an example of data defined in the verb table 500. In the verb table 500, the verb ID 502 is data that identifies record data on the verb table. Likewise, a sender 504 is data that indicates an actor which is a source of the operation. Likewise, a receiver 506 is data that indicates an actor which is a receiver of the operation. Likewise, an input 508 indicates data that is necessary for the operation. Likewise, an output 510 indicates data that is generated by the operation of the actor. Likewise, a verb 512 indicates the name of a verb. Likewise, a sentence example 514 is a template of a step sentence expressed by a verb. When the value of the sender 504, the receiver 506, the input 508 or the output 510 is “-”, this means that, in the verb, the actors of the sender and the receiver cannot make data enter the input and the output.

The flow information storage unit 114 will now be described. As described above, the flow information storage unit 114 includes: a business use case related table 600 that is a database stored in the external storage device 205 and that stores order relationship data between business use cases in a business use case flow 106 generated in the business use case flow generation unit 124 described later; and a business function related table 800 that is generated in the business flow generation unit 126 described later and that stores order relationship data between business functions which are higher-levels of the business use case.

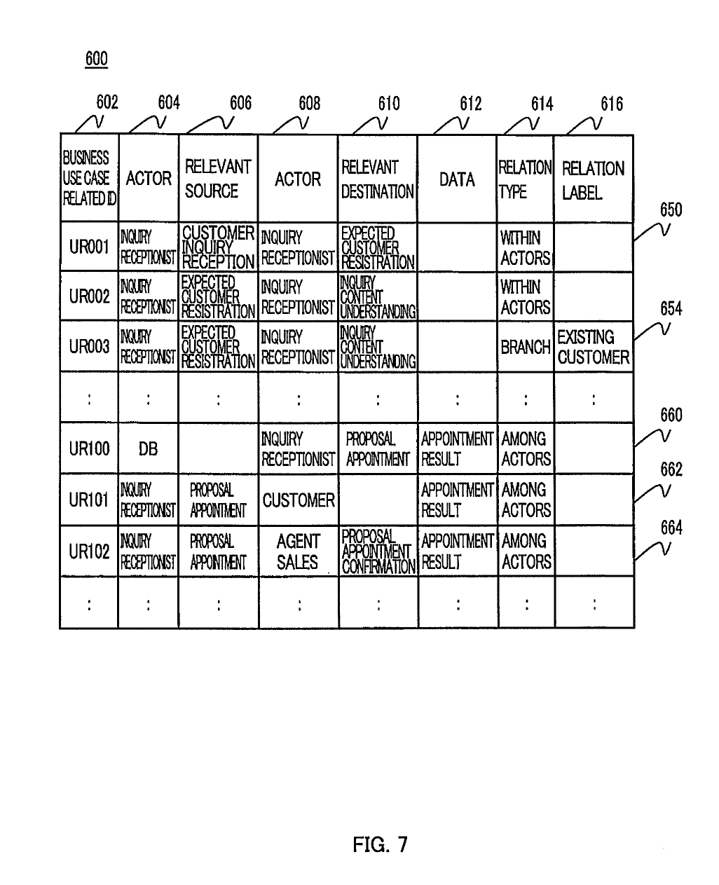

The tables stored in the flow information storage unit 114 will be described below in turn. FIG. 7 shows an example of data defined in the business use case related table 600. In the business use case related table 600, a business use case related ID 602 is data that identifies record data on the business use case related table. With a use case relevant source 606 and a relevant destination 610, it is possible to indicate a relation between the business use cases. An actor 604 indicates an actor of the business use case that enters the relevant source 606; an actor 608 indicates an actor of the business use case that enters the relevant destination 610. Likewise, data 612 indicates data that is exchanged between the actor 604 and the actor 608. Likewise, a relation type 614 is data that indicates a type of a relation between business use cases defined by the relevant source 606 and the relevant destination 610; any one of “within the actor” that indicates a relation within the same actor, “among the actors” that indicates a relation among separate actors and “branch” that indicates a relation produced by the branch destination business use case ID 418 in the business use case description table 400 enters the relation type 614. The name of the relation such as the branch condition enters a relation label 610.

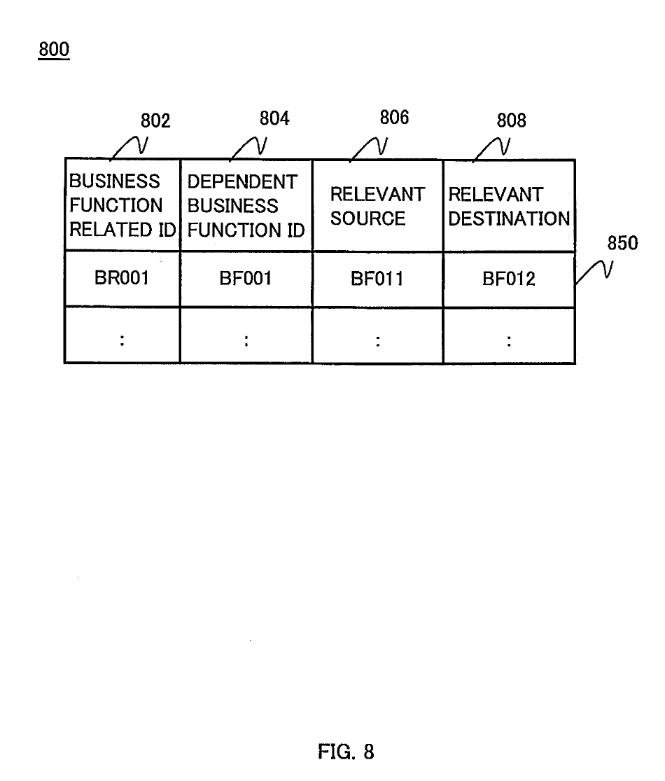

FIG. 8 shows an example of data defined in the business function related table 800. In the business function related table 800, a business function related ID 802 is data that identifies record data on the business function related table. Likewise, a dependent business function ID 804 indicates to which business function the relation between the business functions defined in the business function related table 800 belongs, and the business function ID 702 stored in the business function hierarchy table 700 enters the dependent business function ID 804. The business function ID 702 stored in the business function hierarchy table 700 enters each of a relevant source 806 and a relevant destination 808, and they indicate the relation between the related business functions.

—An Example of Processing—

The actual procedure of a business analysis design support method according to the present embodiment will be described below with reference to accompanying drawing. Various operations corresponding to the business analysis design support method, which will be described below, are realized by a program that is read in the main storage device 202 or the like and executed by the business analysis design support device 100. This program is formed with a code for performing various operations, which will be described below. Here, the processing content for generating the business use case flow 106 and a business flow 108 from the business function hierarchy 102 and the business use case description 104 will first be described with reference to not only FIG. 2 but also the related figures.

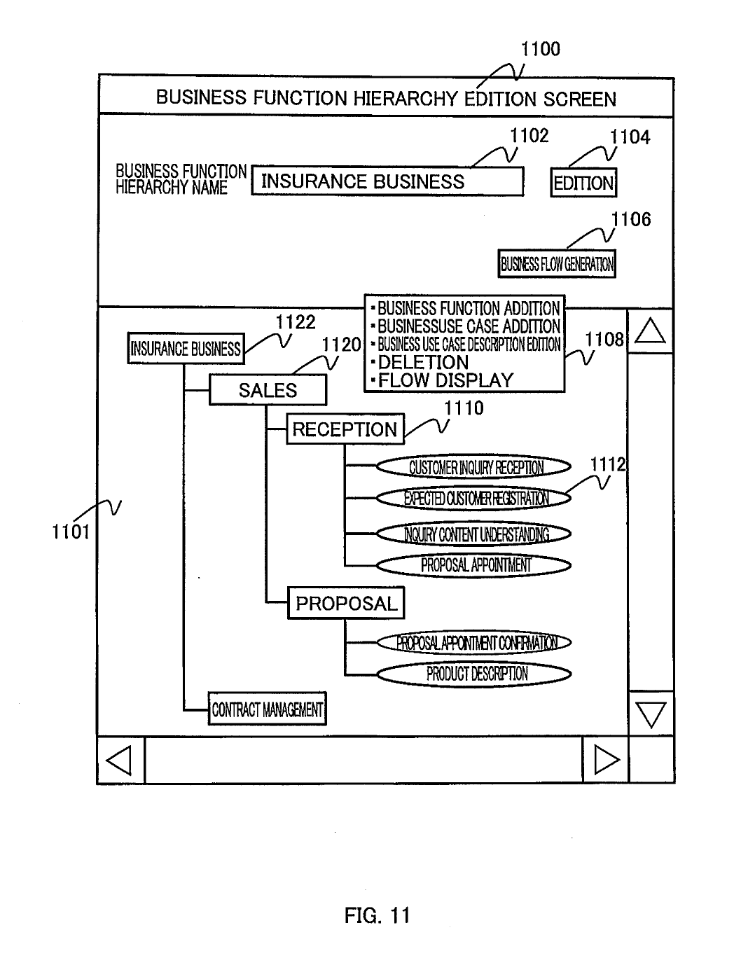

The business function hierarchy 102 is data that is produced through a business function hierarchy edition screen 1100 shown in FIG. 11 by the reception of an input value of the user with the input device 203 by the business function hierarchy edition unit 120. The business function hierarchy edition unit 120 stores the produced date on the business function hierarchy 102 in the business function hierarchy storage unit 110 as the record data of the business function hierarchy table 700 and the business use case table 300. The data on the business function hierarchy edition screen 1100 is previously stored in the external storage device 205 (or the main storage device 202) of the business analysis design support device 100, and can be read as necessary. The same is true for other screens which will be described below.

The example of the edition of the business function hierarchy 102 discussed above will be described with the business function hierarchy edition screen 1100 shown in FIG. 11. In this case, when the user edits the business function hierarchy, the user is assumed to input the name of the business function hierarchy in an input form 1102 and to press down an edition button 1104. Here, the business function hierarchy edition unit 120 searches whether or not the business function hierarchy 102 specified by the name input into the input form 1102 is already stored as the record data of the business function hierarchy table 700 in the business function hierarchy storage unit 110. Specifically, the record data in which the name input into the input form 1102 is present as a stored business function name 704 and in which its higher-level business function ID 706 is “-” is searched for. This is because the business function whose higher-level business function ID 706 is “-” indicates the highest-level business function in the business function hierarchy, and is data representing the business function hierarchy. For example, a record 750 corresponds to such data.

When the corresponding business function has been found by the search described above, the business function hierarchy edition unit 120 searches the business function hierarchy table 700 in the business function hierarchy storage unit 110 for the business function belonging to the business function found by the search and specifies it. Specifically, the business function hierarchy edition unit 120 searches for the business function having, in the higher-level business function ID 706, the same value as the business function ID 702 of the business function found by the search. For example, a record 752 and a record 754 correspond to it. When the corresponding business function has been found by the search, the business function hierarchy edition unit 120 further searches for the business function having, in the higher-level business function ID 706, the same value as the business function ID 702 of this business function, and repeats this search processing until no corresponding business function is found. For example, a record 756 and a record 758 correspond to it.

Then, the business function hierarchy edition unit 120 searches whether or not a business use case having, in the higher-level business function ID 308, the same value as the business function ID 702 of the business function found so far by the search of the processing described above is stored as the record data of the business use case table 300 in the business function hierarchy storage unit 110. For example, a record 350, a record 352, a record 354, a record 356, a record 358 and a record 360 correspond to this. In this way, the business function hierarchy edition unit 120 reads the data in the business function hierarchy 102 of the name input into the input form 1102. The result of the reading is, as shown in the example of FIG. 11, displayed in a lower frame 1101 of the business function hierarchy edition screen 1100 output to the display device 204. In the example of FIG. 11, the business functions and the business use cases are represented by rectangular symbols and oval symbols, respectively, and the relation between them is represented by drawing a line between the symbols, and thus the business function hierarchy is represented.

When the corresponding business function has not been found in the search processing described above, the business function hierarchy edition unit 120 newly generates a business function hierarchy in which the name input into the input form 1102 is the highest-level business function. Specifically, the newly generated business function ID 702 and a new record in which the name input into the input form 1102 is a business function name 704 and the high business function ID 706 is “-” is added to the business function hierarchy table 700.

When the business function and the business use case are added or deleted, the business function hierarchy edition unit 120 receives the selection of a predetermined icon or the like with the input device 203 from the user to display a menu 1108, receives a selection of the user from the menu 1108 and starts processing. For example, when the user performs a click or the like on the symbol 1110 of a business function “reception” to select it, the business function hierarchy edition unit 120 displays the menu 1108 on the display device 204. Then, for example, when “business function addition” is selected from this menu 1108, the business function hierarchy edition unit 120 adds a new business function (example: “proposal” or the like) in the same hierarchy separately from the reception 1110. For example, when “business use case addition” is selected from the menu 1108, the business function hierarchy edition unit 120 adds a new business use case (example: “proposal appointment” or the like) to the hierarchy immediately below the reception 1110. For example, when “deletion” is selected from the menu 1108, the business function hierarchy edition unit 120 deletes the business function of the selected symbol (in the above example, the “reception 1110”) or a business use case belonging to the business function. The business use case is the lowermost layer element in the business function hierarchy, and it is impossible to add the business function and the business use case to below the business use case.

In this way, it is possible to produce, in the business function hierarchy edition unit 120, the business function hierarchy 102 having the business use case as the lowermost layer element.

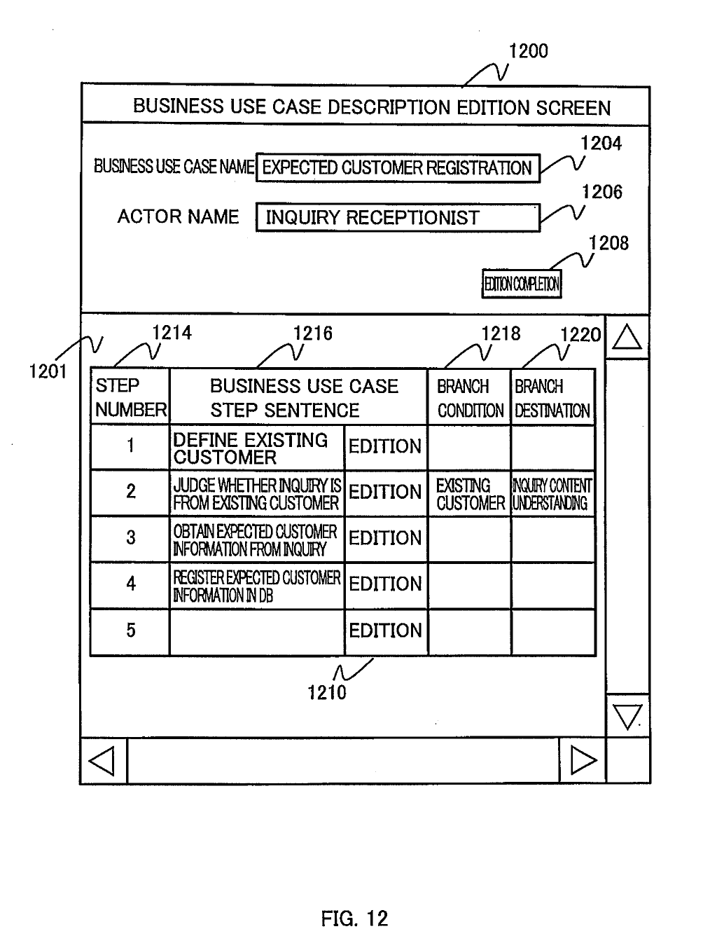

On the other hand, in order for the user to edit the business use case description 104 that is the details of the business use case, the user selects the symbol of the corresponding business use case in the input device 203 to display the menu 1108 described above. In this case, the business function hierarchy edition unit 120 receives the selection of the symbol of the corresponding business use case on the screen 1100 to display the menu 1108, and receives the selection of “business use case description edition” in the menu 1108. When this selection is performed, the business analysis design support device 100 displays a business use case description edition screen 1200 on the display device 204, and receives an edition operation by the user through the business use case description edition unit 122 described below. For example, when a business use case “expected customer registration” 1112 is selected, the business analysis design support device 100 displays the business use case description edition screen 1200 shown in FIG. 12 on the display device 204.

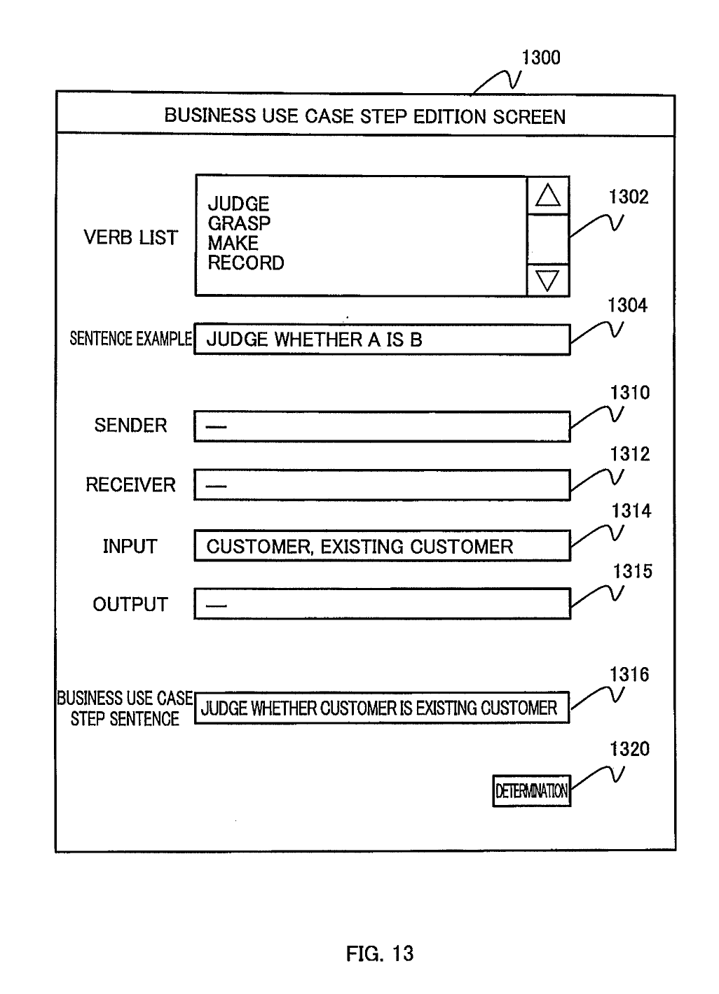

The business use case description edition unit 122 receives, in the input device 203, an input from the user through the business use case description edition screen 1200 shown in FIG. 12 and a business use case step edition screen 1300 shown in FIG. 13, and thus the business use case description 104 is produced. The produced business use case description 104 is stored in the business use case description storage unit 112 by the business use case description edition unit 122 as the record data of the business use case description table 400.

An example of the edition of the business use case description 104 discussed above will be described using the business use case description edition screen 1200 shown in FIG. 12 and the business use case step edition screen 1300 shown in FIG. 13. In order for the user to edit the business use case description 104, the corresponding business use case is selected on the above-described business function hierarchy edition screen 1100, then “business use case description edition” is indicated on the menu 1108 and the business use case description edition screen 1200 on the corresponding business use case is displayed on the display device 204. On the other hand, the business use case description edition unit 122 receives such an indication from the user to display the business use case description edition screen 1200 on the display device 204.

When the user wants to edit the business use case name on the business use case description edition screen 1200, the user inputs the business use case name into an input form 1204 whereas, when the user wants to edit an actor that is the main operational body of the business use case, the user inputs the actor name into an input form 1206. On the other hand, the business use case description edition unit 122 acquires the value of the business use case name through the input form 1204, and acquires the value of the actor that is the main operational body of the business use case through the input form 1206.

As described above, the business use case description edition unit 122 receives the specification and the input on the business use case description 104 from the user, and displays the content thereof on the lower frame 1201 of the business use case description edition screen 1200. In this case, specifically, the business use case description edition unit 122 acquires a record in the business use case description table 400 from the business use case description storage unit 112, further acquires a record in the verb table 500, combines these pieces of information to generate and display the content of the business use case description.

For example, when on the business function hierarchy edition screen 1100, the business function hierarchy “expected customer registration” having a value of “UC002” in the business use case ID 302 is selected, the business use case description edition unit 122 acquires a record having “UC002” in the business use case ID 402 among records in the business use case description table 400. Then, the business use case description edition unit 122 acquires a record in the verb table 500 having the same verb ID 502 as the verb ID 414 of the acquired record, combines, in the template of the use case step given by the sentence example 514, data on the sender 406, the receiver 408, the input 410 and the output 412 and combines a business use case step sentence. For example, when the business use case description edition unit 122 acquires a record 450 in the business use case description table 400, the business use case description edition unit 122 acquires a record 550 in the verb table 500 because the verb ID 414 is “V007”, finds that the “inquiry” of an input “inquiry, existing customer” in the record 450 corresponds to “A” and the “existing customer” corresponds to “B” because the “A” and “B” of “judge whether A is B” given by the sentence example 514 correspond to the input 508 and can combine and generate a use case step sentence 1216 displayed on the business use case description edition screen 1200 as in “judge whether the inquiry is the existing customer.”

In each business use case step displayed in the lower frame 1201 of the business use case description edition screen 1200, a step number 1214 indicates that, in its order, an operation described in the business use case step sentence has been performed. The business use case step sentence 1216 is an item that can be edited by the pressing down of an edition button 1210 by the user. A branch condition 1218 is a condition when processing is branched immediately after the business use case step sentence 1216 is performed. When the branch condition 1218 is satisfied, a branch destination 1220 indicates a business use case that is the transition destination thereof. For example, the branch condition 1218 “it is the existing customer” and the branch destination 1220 “inquiry content understanding” in the figure indicate transition to the business use case “inquiry content understanding” in the case of “it is the existing customer.”

The business use case step sentence 1216 states that edition by the user is received by the pressing down of the edition button 1210. When the user presses down the edition button 1210, the business use case description edition unit 122 displays, on the display device 204, the business use case step edition screen 1300 shown in FIG. 13. On the business use case step edition screen 1300, a verb list 1302 is a unit configured to receive the user selection of a verb indicating an operation performed by the corresponding actor; for example, a list of selectable verbs is displayed in a pull down menu format. The selectable verbs are record data stored in the verb table 500. Here, a description will be given as an example with the assumption that a verb 550 “judge” is selected in the verb list 1302.

In the business use case step edition screen 1300, a sentence example 1304 indicates the sentence example 514 (the verb table 500) of the verb selected in the verb list 1302. Likewise, a sender 1310 corresponds to the sender 504 (the verb table 500), a receiver 1312 corresponds to the receiver 506 (the verb table 500), an input 1314 corresponds to the input 508 (the verb table 500) and an output 1315 corresponds to the output 510 (the verb table 500). In the sender 504, the receiver 506, the input 508, and the output 510, data which is “-” indicates that it is impossible to input the data. For example, in the case of the record 550 in the verb table 500, the input 508 is “A, B” and thus it is found that only the input 1314 can be input by the user; in the example, “customer, existing customer” is input into the input 1314. A business use case step sentence 1316 is data obtained by automatically replacing part of the sentence example 1304 with a character line or a value input in the sender 1310, the receiver 1312, the input 1314 and the output 1315; it is impossible for the user to input it.

It is assumed that the user presses down a determination button 1320 on the business use case step edition screen 1300. In this case, the business use case description edition unit 122 displays the business use case step sentence 1316 on the business use case description edition screen 1200 as the use case step sentence 1216. Here, the business use case step sentence 1316 is displayed as the business use case step sentence 1216 in the left column of the corresponding edition button 1210 according to the pressing down of the edition button 1210 on the business use case description edition screen 1200 that is a starting point of the edition operation of the business use case step sentence.

On the other hand, when an edition completion button 1208 is pressed down on the business use case description edition screen 1200, the business use case description edition unit 122 stores the result of the edition described above as a record in the business use case description table 400.

As described above, in the business use case description edition unit 122, the verbs (described in the verb table 500) defining possible patterns taken by the sender and the receiver of the operation and the input and the output of the data are utilized to produce the steps of the business use case, and thus it is possible to edit the content of the business use case description 104 of the steps.

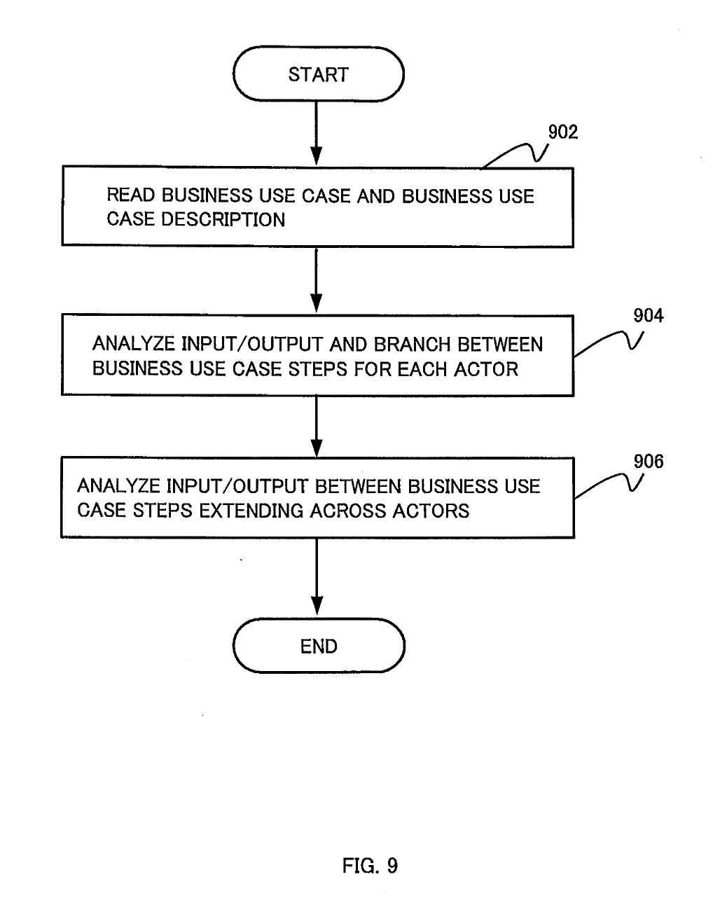

Then, the generation processing of a business use case flow in the business use case flow generation unit 124 will be described according to a processing flow shown in FIG. 9. This processing is started by receiving the pressing down of a business flow generation button 1106 on the business function hierarchy edition screen 1100 by the user.

In this case, in step 902, the business use case flow generation unit 124 reads data on the business use case description 104 edited by the business use case description edition unit 122 from the business use case description storage unit 112. Specifically, when the business flow generation button 1106 on the business function hierarchy edition screen 1100 is pressed down, a record in the business use case table 300 and a record in the business use case description table 400 included in the displayed business function hierarchy are read.

Then, in step 904, the business use case flow generation unit 124 derives the order relationship between business use case steps within the same actor from the relationship of the output and the input between the business use case steps, and registers its result in the flow information storage unit 114 as a record in the business use case related table 600. Simultaneously, the business use case flow generation unit 124 analyzes a branch condition between use cases, and registers its result as a record in the business use case related table 600. Here, as a target of the business use case step to be analyzed, a record in the business use case description table 400 in which the sender 406 and the receiver 408 are empty is a target.

For example, in a record 446 in the business use case description table, “inquiry” is output, in a record 448, “existing customer” is output and in a record 450, “inquiry” and “existing customer” are input. Hence, from the relationship between these outputs and inputs, the business use case flow generation unit 124 recognizes that there is a relation among the business use case step indicated by the record 446, the business use case step indicated by the record 450, the business use case step indicated by the record 448 and the business use case step indicated by the record 450.

Since what is desired to be clarified here is a relation between business use cases, and the relation between the business use case step indicated by the record 446 and the business use case step indicated by the record 450 is a relation extending across business use cases from “customer inquiry reception” to “expected customer registration”, the business use case flow generation unit 124 registers a record 650 in the business use case related table 600.

Since this record 650 is a record in which the business use case related ID 602 newly generated in the record registration is a key, and, in the business use case step specified by the record 446 of the relevant source, its actor is “inquiry receptionist” (FIG. 3), this is set as the actor 604; since the business use case including such a step is “customer inquiry reception” (FIG. 3), this is set as the relevant source 606; since in the business use case step specified by the record 450 of the relevant destination, its actor is “inquiry receptionist” (FIG. 3), this is set as the actor 608; since the business use case including such a step is “expected customer registration” (FIG. 3), this is set as the relevant destination 610; since it is found that both actors of “customer inquiry reception” and “expected customer registration” are “inquiry receptionist”, and it is a relation within the same actor, the relation type 614 is generated as “within the actor.”

The business use case flow generation unit 124 recognizes, in the record 450 in the business use case description table 400, from the branch condition 416 and the branch destination use case ID 418, a branch relation to a business use case “inquiry content understanding”, and generates a record 654 in the business use case related table 600.

Since this record 654 is a record in which the business use case related ID 602 newly generated in the record registration is a key, and, in the business use case step specified by the record 450 of the relevant source, its actor is “inquiry receptionist” (FIG. 3), this is set as the actor 604; since the business use case including such a step is “expected customer registration” (FIG. 3), this is set as the relevant source 606; furthermore, since in the business use case step specified by the record 450 of the relevant destination, its actor is “inquiry receptionist” (FIG. 3), this is set as the actor 608; the business use case including such a step “inquiry content understanding” (FIG. 3) is set as the relevant destination 610; since the relation is caused by a branch, the relation type 614 is set as “branch”; the branch condition 416 is generated as a relation label 616.

Then, in step 906, the business use case flow generation unit 124 derives the order relationship between business use case steps differing in actor from the relationship of the input and the output and the receiver and the sender between the business use case steps, and registers its result in the flow information storage unit 114 as a record in the business use case related table 600. Here, as a target of the business use case step to be analyzed, a record in business use case description table 400 in which the sender 406 and the receiver 408 are not empty is a target.

For example, in a record 452 in the business use case description table 400, the sender 406 is “DB” and the output 412 is “appointment result.” Hence, in this case, the business use case flow generation unit 124 sets the actor 604 as “DB.” The business use case flow generation unit 124 sets, in the business use case step specified by the record 452, the business use case including this “proposal appointment” (FIG. 3) as the relevant destination 610, and simultaneously sets its actor “inquiry receptionist” (FIG. 3) as the actor 608. Moreover, the business use case flow generation unit 124 recognizes, from the value of the output 412, that the exchanged data is “appointment result”, and sets this as the data 612; since the exchange is performed between different actors, the relation type 614 is set as “between the actors”, and a record 660 is registered in the business use case related table 600.

Moreover, in a record 454 in the business use case description table 400, as the receiver 408, two persons “customer, agent sales” are present, and the input 410 is “appointment result.” Hence, in this case, the business use case flow generation unit 124 first sets the actor 608 as the first actor at “customer”, and sets, in the business use case step indicated by the record 454, the business use case “proposal appointment” including this as the relevant source 610, and simultaneously sets its actor “inquiry receptionist” as the actor 604; since the exchanged data is found to be “appointment result” from the input 410, this is set as the data 612; since the relation type 614 is exchange between different actors, a record 662 that is set as “between the actors” is registered in the business use case related table 600.

Then, the business use case flow generation unit 124 sets the actor 608 as the second actor at “agent sales”, and sets, in the business use case step indicated by the record 454, the business use case “proposal appointment” including this as the relevant source 610, and simultaneously sets its actor “inquiry receptionist” as the actor 604; since the exchanged data is found to be “appointment result” from the input 410, this is set as the data 612; since the relation type 614 is exchange between different actors, this is set as “between the actors”; since, from the receiver 408 “agent sales” and the input 410 “appointment result” of the record 454 and the sender 406 “inquiry receptionist” and the output 412 “appointment result” of a record 456, in the business use case step specified by the record 456, a relation with the business use case “proposal appointment confirmation” including this is found, a record 664 in which the relevant destination 610 is set as “proposal appointment confirmation” is registered in the business use case related table 600.

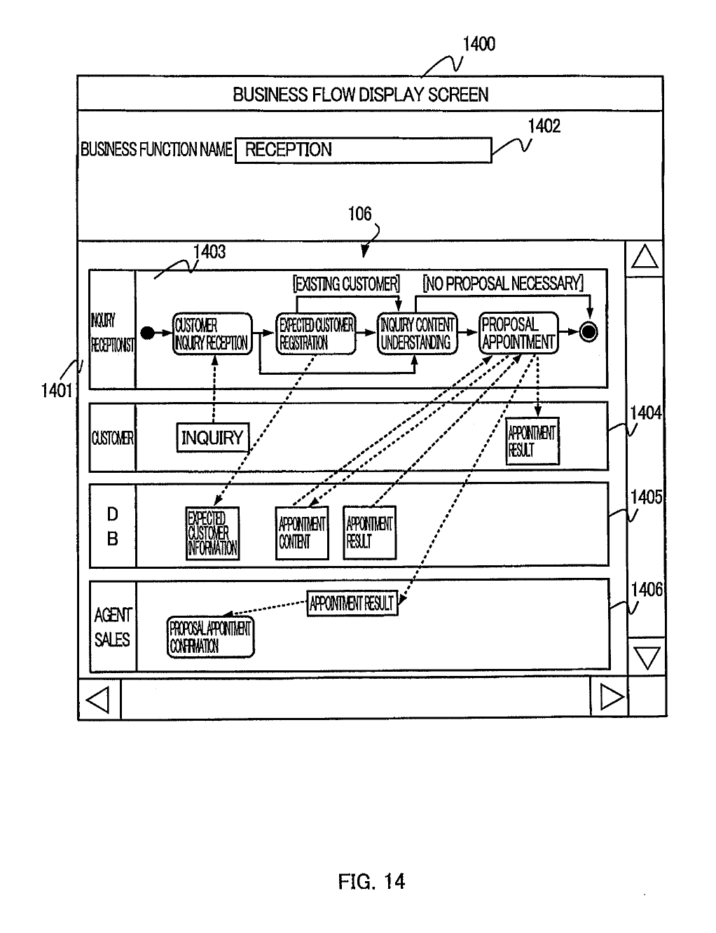

In this way, the business use case flow generation unit 124 analyzes the business use case description 104, and thereby can generate the business use case flow 106. Consequently, as will be described later, it is possible to obtain, for example, a business use case flow shown in a lower frame 1401 of a business flow display screen 1400 shown in FIG. 14.

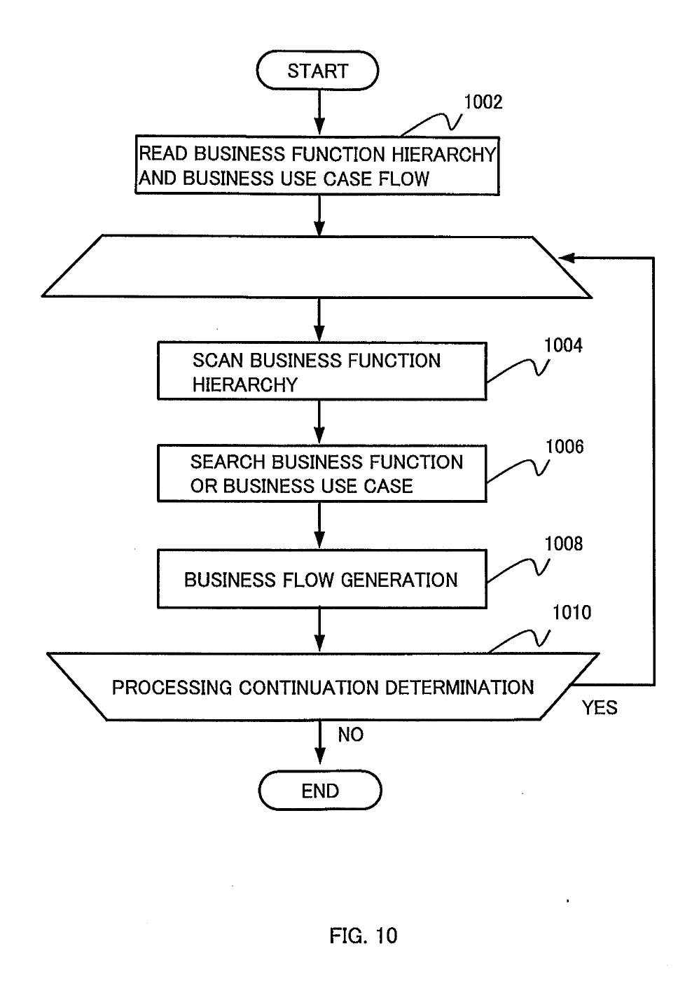

Then, generation processing of a business flow in the business flow generation unit 126 will be described according to a processing flow shown in FIG. 10. This processing is started after the processing in the business use case flow generation unit 124. In this case, in step 1002, the business flow generation unit 126 first reads the business function hierarchy 102 edited in the business function hierarchy edition unit 120 and the business use case flow 106 generated in the business use case flow generation unit 124. As a method of reading the business function hierarchy 102, the same method as the method of reading the existing business function hierarchy 102 with the business function hierarchy edition unit 120 is used.

Since, from step 1004 to step 1010, the business functions of the business function hierarchy 102 read above are scanned from the lower-level to the higher-level, the processing is performed on every few business functions having the same higher-level business functions, from the lower-level business function. For example, in the case of the business function hierarchy shown in the lower frame 1101 in FIG. 11, “reception” and “proposal” having “sales” as a higher-level business function are first processed, and then “sales” and “contract management” having “insurance business” as a higher-level business function are processed.

Here, an example of generating the business flow of “reception” and “proposal” having “sales” as a higher-level business function is first shown. In step 1004, the business flow generation unit 126 scans the business function hierarchy 102, and determines that “reception” and “proposal” having “sales” as a higher-level business function are targets to be processed. Then, in step 1006, the business flow generation unit 126 searches a business function or a business use case as a lower-level of “reception” and “proposal” determined to be the targets to be processed in step 1004 described above. For example, since the business use case exists in the lower-level of “reception” is present, the business flow generation unit 126 first searches a record in the business use case table 300. Specifically, the business flow generation unit 126 obtains information on the business use cases “customer inquiry reception”, “expected customer registration”, “inquiry content understanding” and “proposal appointment” having, in the higher-level business function ID 308, the business function ID “BF011” of “reception.” Likewise, the business flow generation unit 126 first searches a record in the business use case table 300 for the business use cases existing in the lower-level of “proposal.” Specifically, the business flow generation unit 126 obtains information on the business use cases “proposal appointment confirmation” and “product description” having, in the higher-level business function ID 308, the business function ID “BF012” of “proposal.”

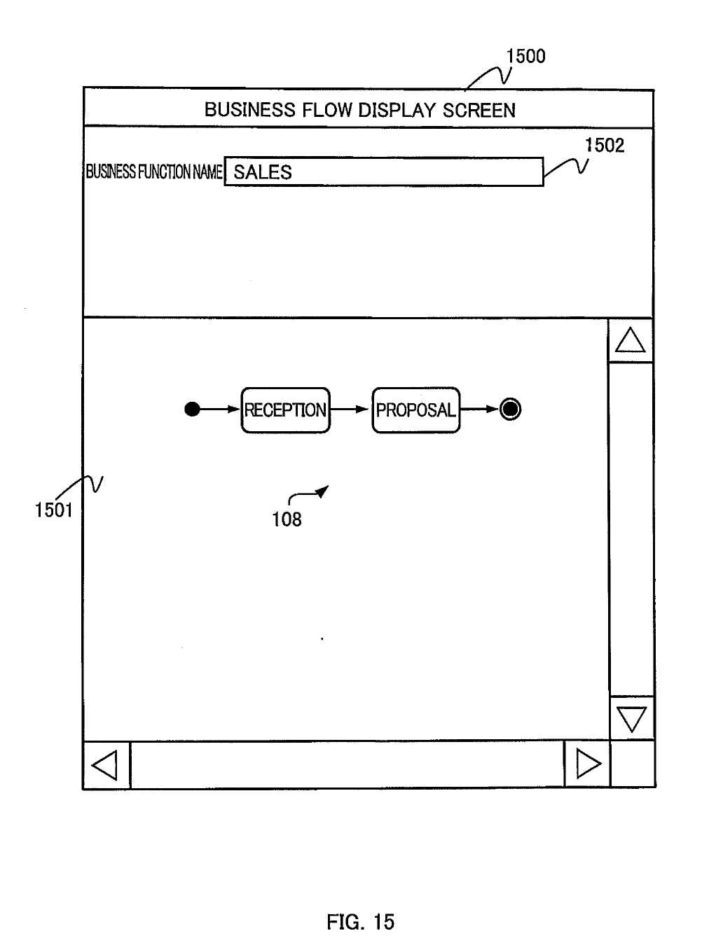

Then, in step 1008, the business flow generation unit 126 generates a business flow based on the information on the business use cases obtained in step 1006 described above. For example, the business flow generation unit 126 obtains a record in the business use case related table 600 that has, as the relevant source 606 or the relevant destination 610, the business use cases “customer inquiry reception”, “expected customer registration”, “inquiry content understanding”, “proposal appointment”, “proposal appointment confirmation” and “product description” obtained in step 1006 described above. The business flow generation unit 126 utilizes this result to specify the relation extending across “reception” and “proposal.” For example, in the business use case related table 600, the values of the relevant source and the relevant destination of a record 664 are a business use case “proposal appointment” belonging to “reception” and a business use case “proposal appointment confirmation” belonging to “proposal.” The business flow generation unit 126 registers the above-described form in which the relevant source 606 and the relevant destination 610 extend between the business use cases as the relation from “reception” to “proposal” and as a record 850 in the business function related table. As will be described later, by utilizing this relation information, it is possible to obtain a business flow shown in a lower frame 1501 of the business flow display screen shown in FIG. 15.

Then, in step 1010, the business flow generation unit 126 performs processing continuation determination. Specifically, whether or not all the business functions other than the highest-level business function have been processed in the business function hierarchy 102 is judged. In the case of the example described above, since processing on the business function “contract management” is left (1010: Yes), the business flow generation unit 126 returns the processing to step 1004. In this step 1004, the business flow generation unit 126 scans the business function hierarchy again, and determines that “sales” and “contract management” having “insurance business” as a higher-level business function are targets to be processed.

Then, in step 1006, the business flow generation unit 126 searches a business function or a business use case existing in the lower-level of “sales” and “contract management” determined to be the targets to be processed in step 1004. For example, since the business function exists in the lower-level of “sales”, the business flow generation unit 126 first searches a record in the business function hierarchy table 700. Specifically, the business flow generation unit 126 obtains information on the business functions “reception” and “proposal” having, in the higher-level business function ID 706, the business function ID “BF001” of “sales”; furthermore, as in the first step 1006, the business use cases “reception” and “proposal” are obtained. Although, likewise, the business flow generation unit 126 searches a business function existing in the lower-level of “contract management”, in the example of the present embodiment, it is assumed that there is no business function hierarchy. Naturally, when there is a business function in the lower-level of “contract management”, the business flow generation unit 126 obtains a business use case as in “sales” described above.

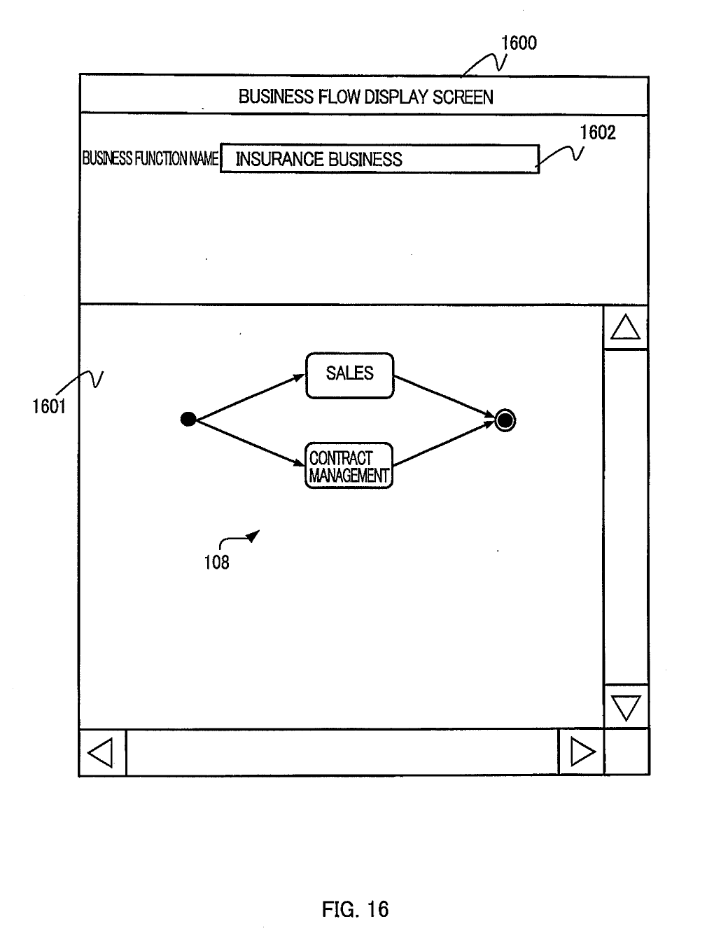

Then, in step 1008, the business flow generation unit 126 generates a business flow based on the information on the business use case obtained in step 1006 described above. However, since there is no business function or business use case in the lower-level of “contract management”, the business flow generation unit 126 judges that there is no relation between “sales” and “contract management.” Consequently, as will be described later, it is possible to obtain the business flow 108 shown in a lower frame 1601 of a business flow display screen shown in FIG. 16, for example.

Then, in step 1010, the business flow generation unit 126 performs the processing continuation determination. However, in the case of the example described above, since there is no business function that is left as an analysis target, the business flow generation unit 126 judges that the processing is completed (1010: No).

In this way, the business flow generation unit 126 can generate the business flow 108 from the business function hierarchy 102 and the business use case flow 106. Consequently, as will be described later, it is possible to obtain the business flow 108 shown in the lower frames 1501 and 1601 of the business flow display screen shown in FIGS. 15 and 16.

Then, the business flow display unit 128 will be described. The business flow display unit 128 displays the business use case flow 106 generated in the business use case flow generation unit 124 or the business flow 108 generated in the business flow generation unit 126. An example of the display of the business use case flow 106 will be described using the business flow display screen 1400 shown in FIG. 14. An example of the display of the business flow 108 will be described using business flow display screens 1500 and 1600 shown in FIGS. 15 and 16.

First, when the user selects a business function represented by a rectangular symbol on the business function hierarchy edition screen 1100, the business analysis design support device 100 displays the menu 1108. When the user selects “flow display” in the menu 1108, the business flow display unit 128 performs display processing in the business use case flow 106 or the business flow 108.

For example, when the “reception” 1110 is selected on the business function hierarchy edition screen 1100, the flow displayed on the display device 204 is the use case flow 106 shown on the business flow display screen 1400 of FIG. 14. In this case, the business flow display unit 128 displays the name of the “reception” 1110 selected by the user as a business function name 1402 on the business flow display screen 1400.

Here, the business flow display unit 128 specifies, in the record in the business use case table 300, the business use case 306 “customer inquiry reception”, “expected customer registration”, “inquiry content understanding” and “proposal appointment” in which the business function ID “BF011” of “reception” is in the higher-level business function ID 308, and specifies a record in the business use case related table 600 including the relevant source 606 or the relevant destination 610 having the same name as the specified business use case 306.

The business flow display unit 128 specifies, from the record specified above, a record in which the relation type 614 is “within the actor”, and assembles, for each actor, the order among the business use cases from the relation between the relevant source 606 and the relevant destination 610. In the business use case flow ordered for each actor, for example, as in a use case flow 1403, a symbol (in the example of the figure, a black circle) indicating the start is coupled to the business use case in the front and a symbol (in the example of the figure, a double circle whose internal circle is black) indicating the completion is coupled to the business use case in the tail end.

Then, the business flow display unit 128 specifies, in the business use case related table 600, a record in which the relation type 614 is “branch”, couples the business use case in the relevant source 606 and the business use case in the relevant destination 610 and displays the content of the relation label 616 above the coupling line. In the example of the use case flow 1403 of FIG. 14, for example, “expected customer registration” and “inquiry content understanding” are coupled with a line, and the content of the relation label 616, “existing customer”, is displayed above the line.

Then, the business flow display unit 128 specifies, in the business use case related table 600, a record in which the relation type 614 is “within the actor”, utilizes, for each actor, the relevant source 606 or the relevant destination 610 and the data 612 and displays data flows 1404, 1405 and 1406. In the example of FIG. 14, data on the business use case flow 1403 about “inquiry receptionist” is exchanged. The dealt data on “customer”, “DB” and “agent sales” and the corresponding business use cases in the use case flow 1403 are coupled with broken lines.

As another example, when the “sales” 1120 is selected on the business function hierarchy edition screen 1100, the flow displayed on the display device 204 is the business flow 108 shown on the business flow display screen 1500 of FIG. 15. In this case, the business flow display unit 128 displays the name of the “sales” 1120 selected by the user as a business function name 1502 on the business flow display screen 1500.

Here, the business flow display unit 128 specifies, in a record in the business function hierarchy table 700, “reception” and “proposal” having the business function ID “BF001” of “sales” as the higher-level business function ID 706, and specifies, in a record in the business function related table 800, the record 850 having the business function ID “BF001” of “sales” as the dependent business function ID 804. The business flow display unit 128 assembles the order of “reception” and “proposal” specified in this way. In the business flow that is the ordered business functions, a symbol representing the start is coupled to the business function in the front, and a symbol representing the completion is coupled to the business function in the tail end (the same symbols as in FIG. 14).

As yet another example, when the “insurance work” 1122 is selected on the business function hierarchy edition screen 1100, the flow displayed on the display device 204 is the business flow 108 shown on the business flow display screen 1600 of FIG. 16. In this case, the business flow display unit 128 displays the name of the “insurance business” 1122 selected by the user as a business function name 1602 on the business flow display screen 1600.

Here, the business flow display unit 128 specifies, in the record in the business function hierarchy table 700, “sales” and “contract management” having the business function ID “BF000” of “insurance work” as the higher-level business function ID 706, and specifies, in the record in the business function related table 800, the record 850 having the business function ID “BF000” of “insurance business” as the dependent business function ID 804. Thus, the business flow display unit 128 assembles the order of “reception” and “proposal” specified above. In the present embodiment, it is assumed that, since there is no corresponding record in the business function related table 800, the order of “reception” and “proposal” does not matter, and a symbol representing the start and a symbol representing the completion for both “business” and “proposal” are coupled.

In this way, in the business flow display unit 128, it is possible to display the business use case flow 106 and the data flow related thereto and the business flow 108.

Although the preferred embodiment and the like for practicing the present invention have been specifically described above, the present invention is not limited to these; various modification are possible without departing from the spirit thereof.

In the present embodiment described above, the business use case description is analyzed, and the order relationship among the business use cases is determined, and thus the business use case flow is generated. Furthermore, the order relationship among the business functions existing in the higher-level of the business use case is determined from the generated business use case flow and the business function hierarchy, and thus the business flow is generated. Hence, it is possible to reduce time and efforts for maintaining the consistency between deliverables in the business analysis design. Moreover, even if an addition or a modification is made in the business use case description, it is possible to immediately reflect them on the business use case flow and the business flow.

It is therefore possible to efficiently maintain the consistency between deliverables in the business analysis design.

The description of the present specification clarifies at least the following. Specifically, the computation device in the business analysis design support device described above may be a device that receives, with the input device, produced data on the business use case which is an element in the business function hierarchy and the lowermost layer of the business function hierarchy or an input of the edition data, and that performs, with the business function hierarchy storage unit, the registration and the edition processing of the business function hierarchy or the business use case.

The storage device in the business analysis design support device described above may be a device that stores a table where possible patterns on the sender and the receiver of the operation in the business use case description and the input and the output of data are defined; the computation device may be a device that reads the pattern from the table to display it on the display device, that receives, with the input device, setting values on the sender and the receiver of the operation and the input and the output of data according to the pattern, that generates the business use case steps of the business use case description corresponding to the pattern, that generates the business use case description formed with the business use case steps and that performs processing stored in the business use case description storage unit.

The computation device in the business analysis design support device described above may be a device that reads, in the processing for generating the business use case flow, the business use case description from the business use case description storage unit, that searches the concatenation of the setting values on the sender and the receiver of the operation defined in each of the business use case descriptions and of the setting of the input and the output of data between the business use case descriptions, that specifies a relation between the business use cases to associate the business use cases with each other and that produces the business use case flow according to the association.

The computation device in the business analysis design support device described above may be a device that specifies, in the processing for displaying the generated business use case flow or the business flow on the display device, the start and the completion of the business use case flow and the business flow using a predetermined setting value in the business use case description as a key and that displays the business use case flow and the business flow on the display device.

The computation device in the business analysis design support device described above may be a device that specifies, in the processing for displaying the generated business use case flow or the business flow on the display device, the concatenation of the input and the output of data on the business use case flow in the business use case description and that produces a display on the display device according to the business use case flow, using the concatenation of the data as a data flow.

What is claimed is:

1. A business analysis design support device comprising:
a storage device that includes:
a business function hierarchy storage unit that stores information on a business function hierarchy where an entire business is structured in a stepwise manner and information on a business use case which is an element of a lowermost layer of the business function hierarchy; and
a business use case description storage unit that stores a business use case description forming the business use case; and
a computation device that performs:
processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association;
processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and
processing of displaying the business use case flow or the business flow generated on a display device.

2. The business analysis design support device according to claim 1,
wherein the computation device receives, with an input device, generated data on the business function hierarchy and the business use case that is the element of the lowermost layer of the business function hierarchy or an input of edition data, and performs processing on registration or edition of the business function hierarchy and the business use case in the business function hierarchy storage unit.

3. The business analysis design support device according to claim 1,
wherein the storage device stores a table that defines a possible pattern on each of a sender and a receiver of an operation and an input and an output of data in the business use case description, and
wherein the computation device performs processing of reading the pattern from the table to display the pattern on the display device, receiving, with the input device, a setting value on each of the sender and the receiver of the operation and the input and the output of data according to the pattern, generating business use case steps of the business use case description corresponding to the pattern, and producing the business use case description formed with the business use case steps to store the business use case description in the business use case description storage unit.

4. The business analysis design support device according to claim 3,
wherein, in the processing of generating the business use case flow, the computation device reads the business use case description from the business use case description storage unit, searches a concatenation of the setting value of the sender and the receiver of the operation and a setting of the input and the output of data defined in each of the business use case descriptions among the business use case descriptions, specifies a relation among the business use case descriptions to associate the business use cases with each other, and generate the business use case flow according to the association.

5. The business analysis design support device according to claim 1,
wherein, in the processing of displaying the business use case flow or the business flow generated on the display device, the computation device specifies a start and a completion of the business use case flow and the business flow using a predetermined setting value in the business use case description as a key and displays the business use case flow and the business flow on the display device.

6. The business analysis design support device according to claim 1,
wherein, in the processing of displaying the business use case flow or the business flow generated on the display device, the computation device specifies a concatenation of the input and the output of data on the business use case flow in the business use case description, and displays, on the display device, the concatenation of the data as a data flow according to the business use case flow.

7. A business analysis design support method,
wherein a computer, which includes a storage device including a business function hierarchy storage unit storing information on a business function hierarchy where an entire business is structured in a stepwise manner and information on a business use case which is an element of a lowermost layer of the business function hierarchy, and a business use case description storage unit storing a business use case description forming the business use case, performs:
processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association;
processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and
processing of displaying the business use case flow or the business flow generated on a display device.

8. A non-transitory computer-readable medium containing a business analysis design support program, causing a computer, which includes a storage device including a business function hierarchy storage unit storing information on a structured business function hierarchy and information on a business use case which is an element of a lowermost layer of the business function hierarchy, and a business use case description storage unit storing a business use case description forming the business use case, to perform:
processing of reading the business use case description from the business use case description storage unit, searching a concatenation of predetermined words defined in each of the business use case descriptions among the business use case descriptions, specifying a relation among the business use cases to associate the business use cases with each other, and generating a business use case flow according to the association;
processing of specifying a business function which is a higher-level of each of the business use cases included in the business use case flow with the information on the business function hierarchy in the business function hierarchy storage unit, specifying a concatenation of the business use cases extending across different business functions in the business use case flow, and associating the business functions with each other according to the concatenation to generate a business flow; and
processing of displaying the business use case flow or the business flow generated on a display device.
